(19) United States
(12) Patent Application Publication
(10) Pub. No.: US 2017/0097110 A1
(43) Pub. Date: Apr. 6, 2017

(54) WIND TURBINE DRIP LOOP CABLE SECUREMENT ASSEMBLY

(71) Applicant: General Electric Company, Schenectady, NY (US)

(72) Inventors: Sirin Hamsho, Niskayuna, NY (US); Timothy W. Jayko, Ballston Lake, NY (US); Andre Langel, Stadtlohn (DE)

(21) Appl. No.: 14/872,526

(22) Filed: Oct. 1, 2015

(51) Int. Cl. F16L 3/12; F03D 9/00; F16L 3/133; F16L 3/137; F16L 3/127; F16L 3/23

(52) U.S. Cl. CPC F16L 3/1218; F16L 3/1222; F16L 3/127; F16L 3/23; F16L 3/133; F16L 3/137; F03D 9/003

(57) ABSTRACT

The present disclosure is directed to a wind turbine drip loop cable securement assembly. The assembly includes at least one flexible ring component and a plurality of flexible straps circumferentially mounted to the flexible ring component. More specifically, the flexible ring component has an inner surface and an outer surface separated by a thickness. The inner surface defines an open center configured to receive the one or more cables therein. Further, the flexible straps have a first end and a second end. Thus, the first end is configured to be mounted to an interior wall of a tower of the wind turbine, whereas the second end is configured to be mounted to the outer surface of the ring component so as to minimize movement of the cables.

### FIELD OF THE INVENTION

The present subject matter relates generally to wind turbines and, more particularly, to assemblies for securing wind turbine drip-loop cables.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and a rotor including one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

In many wind turbines, the nacelle contains electrical components that enable a controlled and efficient conversion of wind energy into electrical energy such as, for example, one or more generators, a wind turbine controller, and/or cooling systems. In addition, cables that feed electrical power into electrical supply grids are often routed from the nacelle to the electrical supply grids via the tower. Thus, a plurality of cables may be present in and around the nacelle, as well as down through the tower (e.g. through openings in one or more tower platforms) so as to couple all of the electrical components to a power source.

To maximize the energy production of a wind turbine, the nacelle is typically able to rotate or pivot versus the fixed position of the tower. This allows the rotor blades to be in an optimum position with respect to the wind direction. Hence, the wind turbine is able to exploit a maximum amount of wind energy at all times. Equally, to avoid unfavorable wind gusts or extremely high wind speeds the position of the nacelle may be adjusted accordingly. The cables described above are typically left free in the drip-loop section in order to twist during nacelle rotation. The twisting behavior of the cables, however, may lead to several issues such as overheating and/or undesired movement of cables. The undesired movement of the cables may cause excessive wear to the cables and/or may damage surrounding structures. In the worst case, such uncontrolled movements of the cables may result in entanglement of the cables inside of the tower that may eventually lead to system failure.

To address the aforementioned issues, fiberglass reinforced material may be installed around the cable bundles and/or rubber mats may be installed within tower platform openings to control undesired movements of the cables. In certain wind turbines, however, the fiberglass reinforced material fails to stay installed around the cables. Additional methods for protecting drip loop cables include utilizing large PVC tubing installed within tower platform openings. However, in many cases, such tubing results in high cable air temperatures. Still further methods for protecting the cables include mounting a fixed metal ring around the cables and securing the metal ring to a fixed bracket within the tower to constrain cable movement. However, since the cables continuously move vertically and horizontally, the metal ring can cause cable abrasion issues.

In view of the foregoing, an improved system for securing the drip loop cables of the wind turbine would be welcomed in the art.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a cable securement assembly for minimizing movement of one or more cables within a wind turbine. The cable securement assembly includes at least one flexible ring component having an inner surface and an outer surface separated by a thickness. The inner surface defines an open center configured to receive the one or more cables therein. Further, the cable securement assembly includes at least one flexible strap having a first end and a second end. More specifically, the first end is configured to be mounted to an interior wall of a tower of the wind turbine, whereas the second end is configured to be mounted to the outer surface of the ring component so as to constrain movement of the cables to an acceptable range.

In one embodiment, the cable securement assembly includes a plurality of flexible straps mounted circumferentially around the flexible ring component. In another embodiment, the plurality of flexible straps may include any suitable flexible straps, including but not limited to springs, elastic ropes, elastic cords, ethylene propylene diene monomer (EPDM) straps, or similar.

In further embodiments, the flexible ring component is constructed of at least one of plastic (e.g. polyvinyl chloride (PVC)), fabric, rubber, silicon, or any other suitable flexible material. In additional embodiments, the cable(s) within the wind turbine do not contact the flexible ring component. For example, in certain embodiments, the cable securement assembly may also include one or more spacers configured to separate the cables such that the cables are held in place and do not contact the flexible ring component.

In another embodiment, the flexible ring component may be configured to fit at least partially within an opening of a platform within a tower of the wind turbine. Alternatively, the flexible ring component may be configured above or below the platform tower.

In certain embodiments, the cable securement assembly may include a plurality of brackets, e.g. eye brackets or similar, mounted to the interior wall of the tower. Thus, the first ends of the plurality of flexible straps may be secured to the interior wall of the tower via the plurality of brackets. Further, the cable securement assembly may further include a plurality of eyelets mounted to the outer surface of the ring component. Thus, the second ends of the plurality of flexible straps may be secured to the flexible ring component via the plurality of eyelets.

In particular embodiments, the flexible ring component may be formed from one continuous piece of material. Thus, in certain embodiments, the continuous piece of material may include a slot, for example, to allow insertion of the cables. Alternatively, the flexible ring component may have a segmented configuration, i.e. formed from multiple pieces of material.

In another aspect, the present disclosure is directed to a wind turbine. The wind turbine includes a tower secured to a support surface. Further, the tower may include at least one platform configured therein. The wind turbine also includes a nacelle configured atop the tower and a plurality of electrical cables extending through the tower and nacelle. Thus, the wind turbine also includes a cable securement assembly configured to minimize movement of the cables. The cable securement assembly includes a flexible ring component having an inner surface and an outer surface separated by a thickness. The inner surface defines an open center configured to receive the cable(s) therein. The cable securement assembly also includes at least one flexible strap having a first end and a second end. More specifically, the first end is mounted to an interior wall of a tower of the wind turbine, whereas the second end is mounted to the outer surface of the ring component. It should be understood that the wind turbine may further include any of the additional features as described herein.

In yet another aspect, the present disclosure is directed to a method for minimizing movement of one or more cables or cable bundles within a wind turbine tower. The method includes securing a plurality of first ends of a plurality of flexible straps to an interior wall of the tower and securing a plurality of opposing, second ends of the plurality of flexible straps to an outer surface of a flexible ring component such that the flexible ring component is suspended within the tower. The method further includes inserting the cables within the flexible ring component, wherein the flexible straps minimize movement of the cables as a function of at least one of a length or elasticity of the flexible straps. It should be understood that the method may further include any of the additional steps and/or features as described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates an internal, perspective view of one embodiment of a nacelle of a wind turbine according to the present disclosure;

FIG. 3 illustrates an internal, perspective view of one embodiment of a tower of a wind turbine, particularly illustrating a cable securement assembly according to the present disclosure;

FIG. 4 illustrates a detailed view of the cable securement assembly of FIG. 3;

FIG. 5 illustrates a top, perspective view of one embodiment of a cable securement assembly for a wind turbine according to the present disclosure; and

FIG. 6 illustrates a detailed view of another embodiment of the cable securement assembly according to the present disclosure;

FIG. 7 illustrates a flow diagram of one embodiment of a method for minimizing movement of one or more cables within a wind turbine tower according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “cable” is intended to be representative of any type of cable such as, for example, single- double- or triple-core power cables, radial field or collectively shielded power cables or any other conductive or non-conductive cables or cords that are routed from the nacelle to the tower of a wind turbine, for example, control cables.

Generally, the present disclosure is directed to a wind turbine system that controls movements of internal cables configured therein and protects said cables from mechanical abrasion. More specifically, the wind turbine system may include a cable securement assembly having at least one flexible ring component with an inner surface and an outer surface separated by a thickness. The inner surface defines an open center configured to receive the one or more cables therein. Further, the cable securement assembly includes at least one flexible strap having a first end and a second end. Thus, the first end may be mounted to an interior wall of a tower of the wind turbine, whereas the second end may be mounted to the outer surface of the ring component so as to minimize movement of the cables. Accordingly, the flexible straps are configured to constrain the movement of the cables to an acceptable range, which is determined by the length and/or elasticity of the flexible straps that support the ring component. In other words, if the cables sway in a first direction, opposing straps will be tensioned until the straps reach the maximum length and stop the cables from further movement.

Accordingly, the various embodiments of the present disclosure prevent several issues associated with wind turbine cables, including, but not limited to overheating, movement (or entanglement) of the cables, and/or unnecessary wear on the cables and surrounding structures. Further, the cable securement assembly of the present disclosure allows the cables to move without damaging the cables. Moreover, the assembly has a fixed location with flexible motion to allow the cables and tower to move freely. In addition, the assembly is flexible in that it can be modified in length (e.g. by replacing the straps) on site as needed without replacing the entire assembly. As such, the cable securement assembly provides an economic solution to various challenges faced in the art relating to cable abrasion. Further, the cable securement assembly of the present disclosure may also increase the reliability and service life of wind turbines by minimizing the risk of system failure due to entanglement of the cables. Such system failures may require interrupting the operation of a wind turbine for de-entanglement or repairs associated with uncontrolled cables.

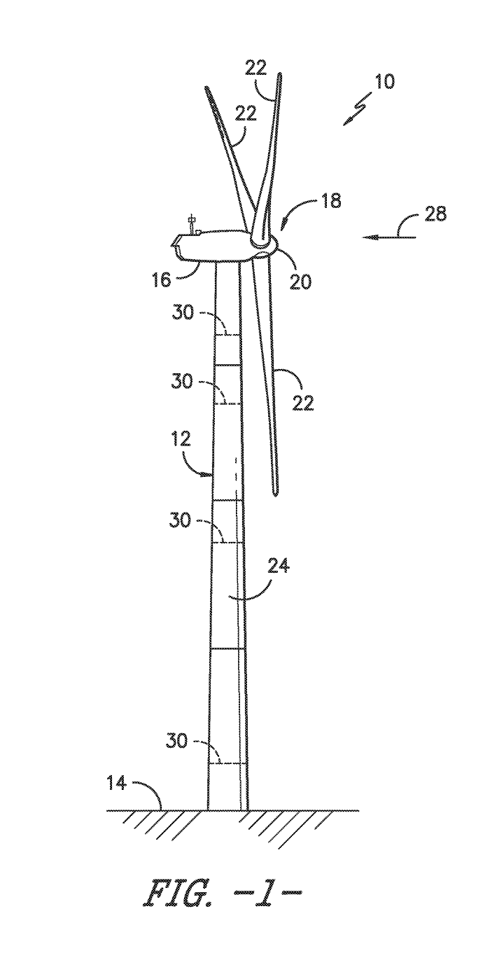

Referring to the drawings, FIG. 1 illustrates a perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to the nacelle 16, which encloses an electric generator (not shown) to permit electrical energy to be produced.

The tower 12 may also include a plurality of tower sections 24 assembled atop one another. Further, the tower 12 may be constructed of any number of tower sections 24. For example, in the illustrated embodiment, the tower 12 includes four tower sections 24. In addition, the tower sections 24 may include one or more platforms 30 that are integrated and/or mounted with a tower section 24.

The platforms 30 are configured to provide operators safe access to areas of the wind turbine 10 that may require servicing, maintenance, and/or inspection. For example, the platforms 30 may be located adjacent to tower flange bolts for safe and easy inspection, or may be located adjacent to preassembled power modules for inspection and maintenance purposes. Thus, the location of the platforms 30 within a tower section 24 may vary so as to accommodate the needs of a specific wind turbine 10.

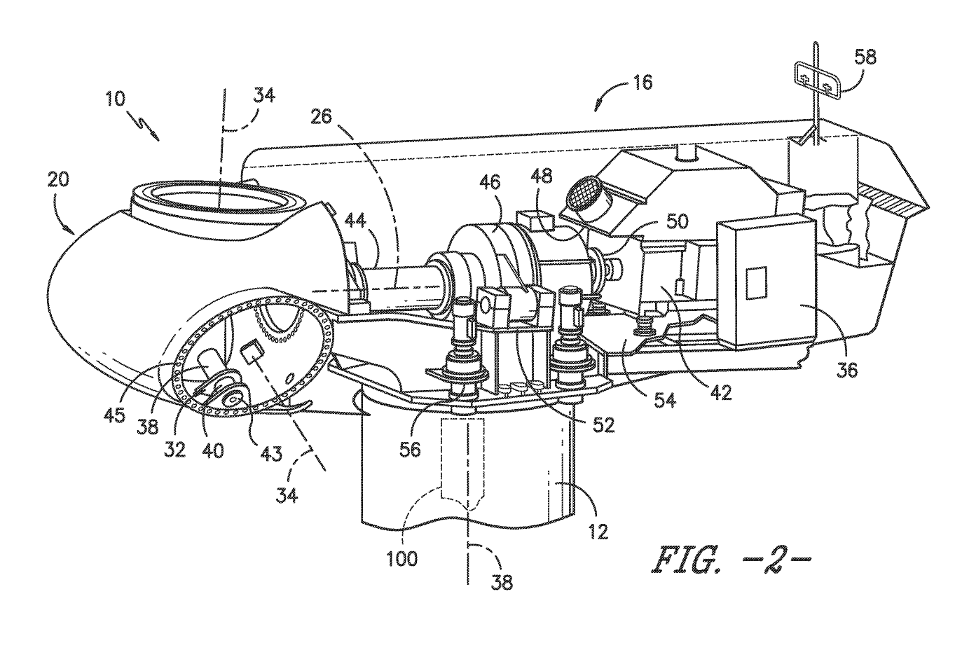

Referring now to FIG. 2, an enlarged perspective view of the nacelle 16 of the wind turbine 10 including the cable securement assembly 60 for minimizing movement of one or more cables 66 within the tower 12 according to the present disclosure is illustrated. As shown, the hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. Further, the rotor shaft 44 is disposed coaxial to longitudinal axis 26. Rotation of the rotor shaft 44 rotatably drives the gearbox 46 that subsequently drives the high speed shaft 48. Thus, the high speed shaft 48 rotatably drives the generator 42 with the coupling 50 and rotation of the high speed shaft 48 facilitates production of electrical power by the generator 42. In addition, as shown in the illustrated embodiment, the gearbox 46 and the generator 42 may be supported by support 52 and support 54. In the exemplary embodiment, the gearbox 46 utilizes dual-path geometry to drive the high speed shaft 48. Alternatively, the rotor shaft 44 may be coupled directly to the generator 42 with the coupling 50.

Each rotor blade 22 may also include a pitch adjustment mechanism 32 configured to rotate each rotor blade 22 about its pitch axis 34. For example, as shown, the pitch adjustment mechanism 32 may include a pitch drive motor 38 (e.g., any suitable electric motor), a pitch drive gearbox 40, and a pitch drive pinion 43. In such embodiments, the pitch drive motor 38 may be coupled to the pitch drive gearbox 40 such that the pitch drive motor 38 imparts mechanical force to the pitch drive gearbox 40. Similarly, the pitch drive gearbox 40 may be coupled to the pitch drive pinion 43 for rotation therewith. The pitch drive pinion 43 may, in turn, be in rotational engagement with a pitch bearing 45 coupled between the hub 20 and a corresponding rotor blade 22 such that rotation of the pitch drive pinion 43 causes rotation of the pitch bearing 45. Thus, in such embodiments, rotation of the pitch drive motor 38 drives the pitch drive gearbox 40 and the pitch drive pinion 43, thereby rotating the pitch bearing 45 and the rotor blade 22 about the pitch axis 34.

The nacelle 16 may also include a yaw drive mechanism 56 that may be used to rotate the nacelle 16 and the hub 20 about the yaw axis 38 to control the perspective of the rotor blades 22 with respect to the wind direction 28 (FIG. 1). In addition, the nacelle 16 may also include at least one meteorological mast 58 that includes a wind vane and anemometer (neither shown in FIG. 2). The mast 58 provides information to control system 36 that may include wind direction and/or wind speed. The control system 36 is configured to control the wind turbine 10 and/or any wind turbine components thereof

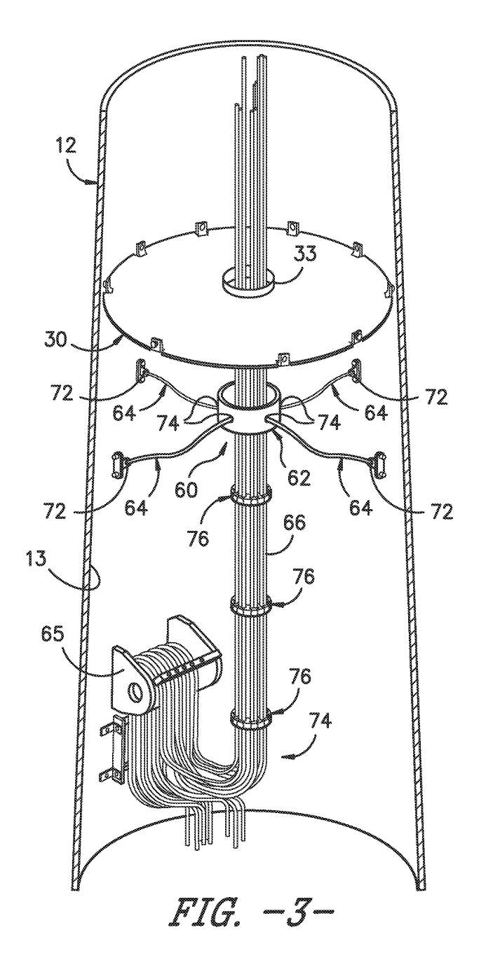

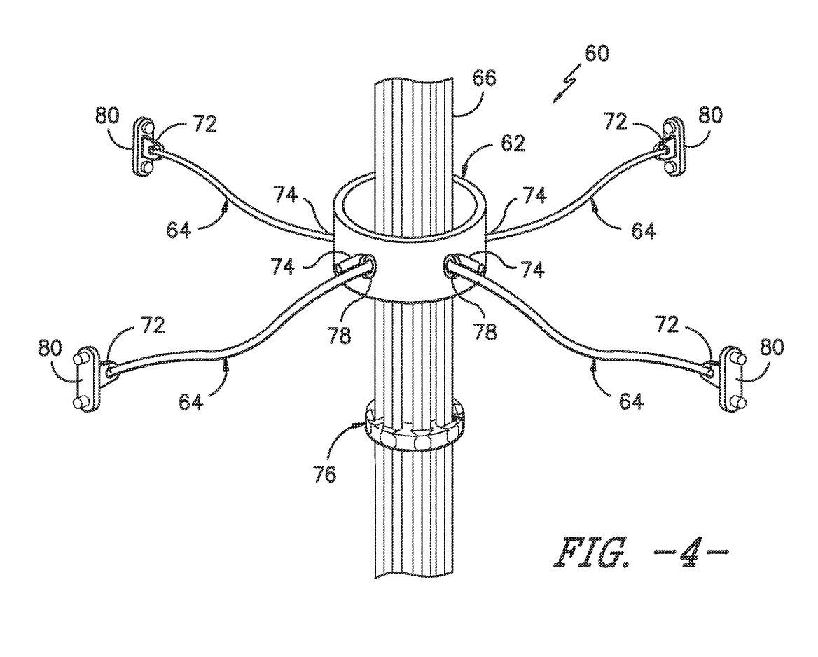

Referring now to FIGS. 3 and 4, various views of one embodiment of the cable securement assembly 60 and example locations for the assembly 60 within the tower 12 are illustrated according to the present disclosure. For example, as shown, the tower 12 includes a plurality of cables 66 configured therein. More specifically, as shown, the plurality of cables 66 are routed from the nacelle 16 (FIG. 2) down through the tower 12 near the support surface 14 in a drip loop configuration. Thus, any platform(s) 30 within the tower 12 contain at least one platform opening 33 configured to allow the cables 66 to pass therethrough. Further, the cables 66 may be routed through a drip loop saddle 65 or saddle deck that is typically located towards a lower portion of the tower 12 and is configured to hold the lower ends of the cables 66.

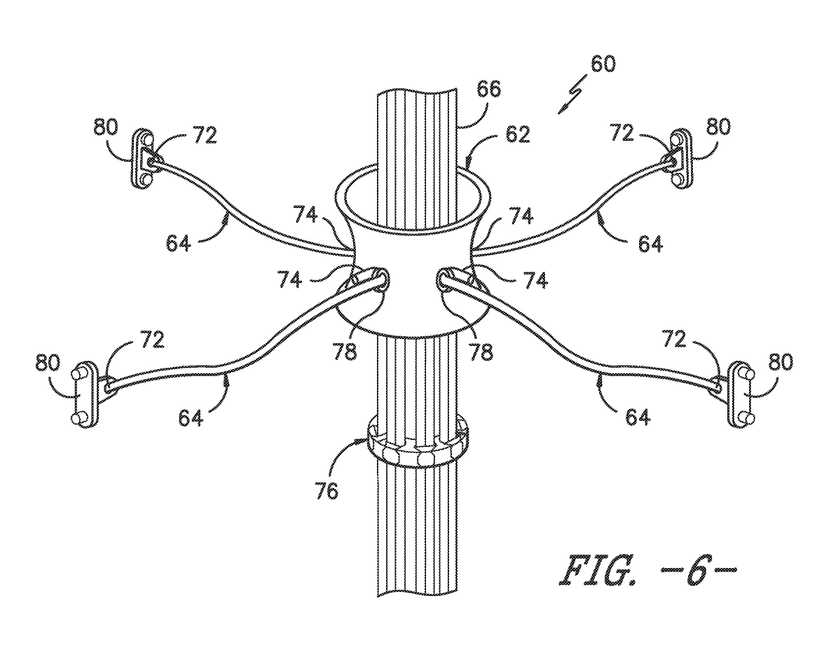

Further, as shown in FIGS. 3-6, the cable securement assembly 60 includes one or more flexible ring component(s) 62. For example, as shown in FIG. 4, the flexible ring component 62 may have a generally tube-shaped body. Alternatively, as shown in FIG. 6, the flexible ring component 62 may have a generally hour-glass shaped body. In such an embodiment, the ring component 62 includes a wider opening 82 at the top and bottom of the ring component 62 to avoid cable damage at such locations when the cables 66 move up and/or down.

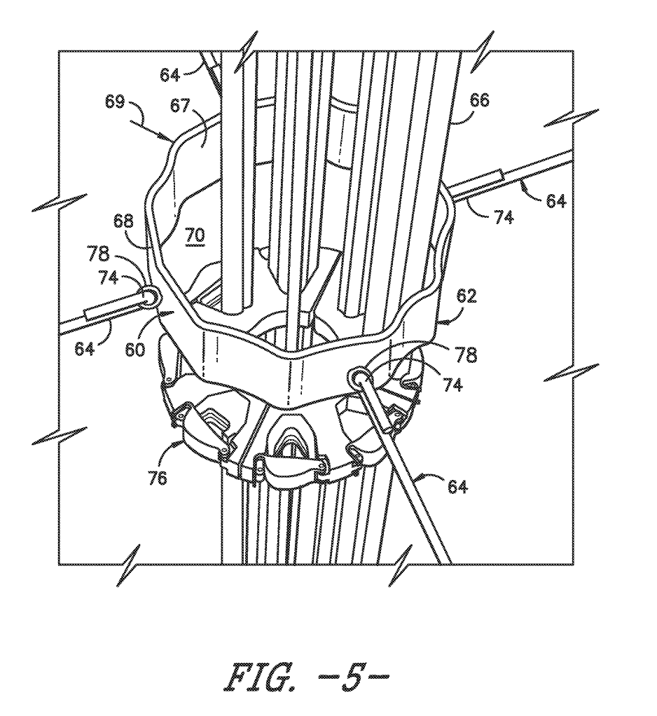

In addition, as shown particularly in FIG. 5, the flexible ring component 62 includes an inner surface 67 and an outer surface 68 separated by a thickness 69. In addition, the inner surface 67 defines an open center 70 configured to receive the cables 66 therein. Thus, the flexible ring component 62 is configured to surround the power cables 66 in the drip loop section of the tower 12 and constrain cable movement to a minimum amount. Further, the flexible ring component 62 may be constructed of any suitable flexible material, including but not limited to plastic, fabric, rubber, silicon, or any other suitable flexible material. For example, in certain embodiments, the plastic material may include polyvinyl chloride (PVC), polyethylene, or similar. As used herein, the term “flexible” generally encompasses the ability of a material to bend without breaking

In particular embodiments, as generally shown in the figures, the flexible ring component 62 may be formed from one continuous piece of material. In such embodiments, the continuous piece of material may include a slot, for example, to allow insertion of the cables 66. Alternatively, the flexible ring component 62 may have a segmented configuration.

Further, the flexible ring component 62 may be located at any location along the vertical run of the drip loop cables 66. For example, in certain embodiments, the flexible ring component 62 may be located within the platform opening 33. Alternatively, as shown in FIG. 3, the flexible ring component 62 may be located underneath tower platform opening 30. In further embodiments, the flexible ring component(s) 62 may be located at any other location along the drip loop cables 66, in addition to those specific locations described herein.

Referring still to FIGS. 3-6, the cable securement assembly 60 also includes at least one flexible strap 64, e.g. mounted circumferentially around the flexible ring component 62. Thus, the flexible ring component 62 is suspended within the tower 12 by the flexible strap(s) 64 that are mounted to the tower 12 so as to control the movement of the cables 66. More specifically, in certain embodiments, the flexible straps 64 may include any suitable flexible straps, including but not limited to springs, elastic ropes, elastic cords, ethylene propylene diene monomer (EPDM) straps, or similar. Thus, the flexible straps 64 can be maintained at a certain tension so as to suspend the flexible ring component 62 at a certain height within the tower 12 and/or to minimize movement of the ring component 62.

For example, as shown, the flexible strap(s) 64 each have a first end 72 and a second end 74. Further, as shown, the first end 72 of the flexible ring component 62 may be mounted to an interior wall 13 of the tower 12 of the wind turbine 10. In addition, the second end 74 may be mounted to the outer surface 68 of the ring component 62. More specifically, as shown in FIG. 5, the cable securement assembly 60 may further include a plurality of eyelets 78 mounted to the outer surface 68 of the ring component 62. Thus, the second ends 74 of the plurality of flexible straps 64 may be secured to the flexible ring component 60 via the plurality of eyelets 78. In addition, as shown in FIGS. 3-5, the cable securement assembly 60 may include a plurality of brackets 80, e.g. eye brackets, mounted to the interior wall 13 of the tower 12. Thus, the first ends 72 of the plurality of flexible straps 64 may be secured to the interior wall 13 of the tower 12 via the plurality of brackets 80. As such, the flexible straps 64 are configured to constrain the movement of the cables 66 to an acceptable range, which is determined by the length and/or elasticity of the flexible straps 64 that support the ring component 62. In other words, if the cables 66 sway in a first direction, opposing straps 64 will be tensioned until the straps 64 reach the maximum length so as to stop the cables 60 from further movement.

In addition, as shown in FIGS. 3-6, the assembly 60 may also include at least one separate cable spacer 76 that provides secure spacing of the cables 66 so as to manage thermal performance and mechanical protection thereof. In certain embodiments, the cable spacers 76 may have a plate configuration with one or more through holes configured to receive one or more of the cables 66 therein. Thus, in certain embodiments, the spacers 76 prevent the cables 66 within the wind turbine 10 from contacting the flexible ring component 62. As such, the cable securement assembly 60 of the present disclosure is configured to reduce damage to the cable spacer 76 during operation as the flexible ring component 62 may be located outside of the cable spacers 76 movement range.

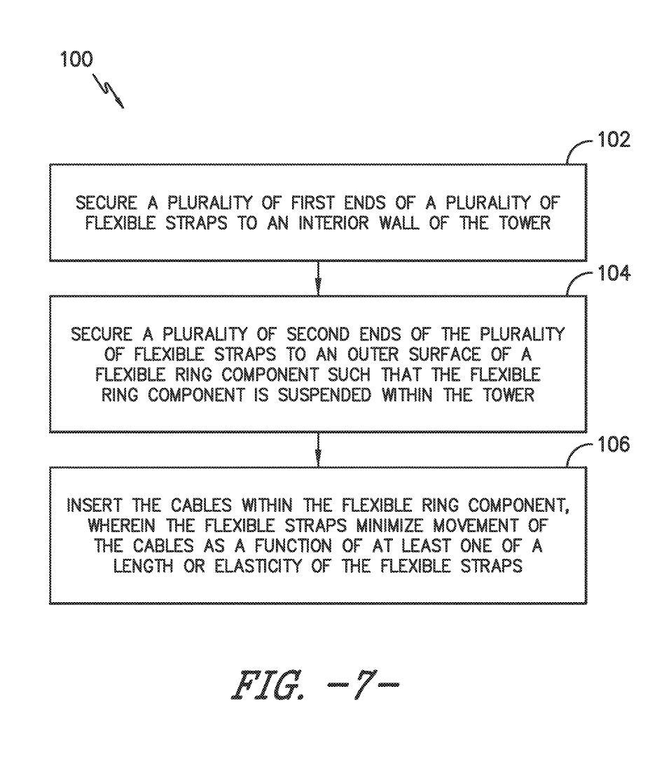

Referring now to FIG. 7, a flow diagram of a method 100 for minimizing movement of one or more cables 66 within a wind turbine tower 12 is illustrated. For example, as shown at 102, the method 100 includes securing a plurality of first ends 72 of a plurality of flexible straps 64 to an interior wall 13 of the tower 12. As shown at 104, the method 100 also includes securing a plurality of opposing, second ends 74 of the plurality of flexible straps 64 to an outer surface 68 of a flexible ring component 62 such that the ring component 62 is suspended within the tower 12. Further, as shown at 106, the method 100 includes inserting the cables 66 within the flexible ring component 62, wherein the flexible straps 64 minimize movement of the cables 66 as a function of at least one of a length and/or elasticity of the flexible straps 64. Thus, the flexible ring component 62 and corresponding straps 64 have a fixed location with flexible motion to allow the cables 66 and tower 12 to move freely.

The above-described systems and methods facilitate for controlling the twisting of cables and/or to protect said cables from mechanical wear, which are routed from the nacelle into the tower of a wind turbine so as to prevent system malfunctions, overheating, and/or undesired movement of the cables within the tower. Additionally, system safety may be increased and excessive wear of the cables or cable bundles as well as wear on surrounding structures, such as, for example, ladders or lights may be reduced.

The systems and methods of the present disclosure are not limited to the specific embodiments described herein, but rather, components of the systems and/or steps of the methods may be utilized independently and separately from other components and/or steps described herein. For example, the cable securement assembly may be employed in other wind turbines, for example vertical wind turbines, other power generating machines or devices where at least one cable is routed from one section to another, whereby the one section moves in opposing directions to the other, and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cable securement assembly for minimizing movement of one or more cables within a wind turbine, the cable securement assembly comprising:
at least one flexible ring component comprising an inner surface and an outer surface separated by a thickness, the inner surface defining an open center configured to receive the one or more cables therein; and,
at least one flexible strap comprising a first end and a second end, the first end configured for mounting to an interior wall of a tower of the wind turbine, the second end configured for mounting to the outer surface of the ring component.

2. The cable securement assembly of claim 1, further comprising a plurality of flexible straps mounted circumferentially around the flexible ring component.

3. The cable securement assembly of claim 2, wherein the plurality of flexible straps comprise at least one of springs, elastic ropes, elastic cords, or ethylene propylene diene monomer (EPDM) straps.

4. The cable securement assembly of claim 1, wherein the flexible ring component is constructed of at least one of plastic, fabric, rubber, or silicon.

5. The cable securement assembly of claim 1, wherein the one or more cables within the wind turbine do not contact the flexible ring component.

6. The cable securement assembly of claim 1, wherein the flexible ring component is configured to fit at least partially within at least one of an opening of a platform within a tower of the wind turbine.

7. The cable securement assembly of claim 2, further comprising a plurality of brackets mounted to the interior wall of the tower, the first ends of the plurality of flexible straps being secured to the interior wall of the tower via the plurality of brackets.

8. The cable securement assembly of claim 7, further comprising a plurality of eyelets mounted to the outer surface of the ring component, the second ends of the plurality of flexible straps being secured to the flexible ring component via the plurality of eyelets.

9. The cable securement assembly of claim 1, wherein the flexible ring component is formed from one continuous piece of material.

10. The cable securement assembly of claim 1, wherein the flexible ring component comprises a segmented configuration.

11. A wind turbine, comprising:
a tower secured to a support surface, the tower comprising at least one platform configured therein;
a nacelle configured atop the tower;
a plurality of cables extending through the tower and nacelle; and, a cable securement assembly configured to minimize movement of the plurality of cables, the cable securement assembly comprising:
at least one flexible ring component comprising an inner surface and an outer surface separated by a thickness, the inner surface defining an open center configured to receive the one or more cables therein, and
at least one flexible strap comprising a first end and a second end, the first end being mounted to an interior wall of a tower of the wind turbine, the second end being mounted to the outer surface of the ring component.

12. The wind turbine of claim 11, further comprising a plurality of flexible straps mounted circumferentially around the flexible ring component.

13. The wind turbine of claim 12, wherein the plurality of flexible straps comprise at least one of springs, elastic ropes, elastic cords, or ethylene propylene diene monomer (EPDM) straps.

14. The wind turbine of claim 11, wherein the flexible ring component is constructed of at least one of plastic, fabric, rubber, or silicon.

15. The wind turbine of claim 11, wherein the one or more cables within the wind turbine do not contact the flexible ring component.

16. The wind turbine of claim 11, wherein the flexible ring component is configured to fit within at least one of an opening of the platform of the tower.

17. The wind turbine of claim 12, further comprising a plurality of brackets mounted to the interior wall of the tower, the first ends of the plurality of flexible straps being secured to the interior wall of the tower via the plurality of brackets.

18. The wind turbine of claim 17, further comprising a plurality of eyelets mounted to the outer surface of the ring component, the second ends of the plurality of flexible straps being secured to the flexible ring component via the plurality of eyelets.

19. The wind turbine of claim 11, wherein the flexible ring component is formed from one continuous piece of material.

20. A method for minimizing movement of one or more cables within a wind turbine tower, the method comprising:
securing a plurality of first ends of a plurality of flexible straps to an interior wall of the tower;
securing a plurality of second ends of the plurality of flexible straps to an outer surface of a flexible ring component such that the flexible ring component is suspended within the tower; and,
inserting the cables within the flexible ring component, wherein the flexible straps minimize movement of the cables as a function of at least one of a length or elasticity of the flexible straps.
